(19) United States
(12) Patent Application Publication
(10) Pub. No.: US 2021/0019318 A1
(43) Pub. Date: Jan. 21, 2021

(54) MATERIALIZED VIEWS FOR DATABASE QUERY OPTIMIZATION

(71) Applicants: Ting Yu Leung, San Jose, CA (US); Yingpong Chen, San Jose, CA (US); Yinglong Xia, San Jose, CA (US)

(72) Inventors: Ting Yu Leung, San Jose, CA (US); Yingpong Chen, San Jose, CA (US); Yinglong Xia, San Jose, CA (US)

(21) Appl. No.: 16/948,940

(22) Filed: Oct. 6, 2020

Related U.S. Application Data
(63) Continuation of application No. PCT/CN2019/106062, filed on Sep. 17, 2019.
(60) Provisional application No. 62/734,667, filed on Sep. 21, 2018.

(51) Int. Cl. G06F 16/2453; G06F 16/23; G06F 16/2455

(52) U.S. Cl. CPC G06F 16/24539; G06F 16/2393; G06F 16/24537; G06F 16/24544; G06F 16/2456

(57) ABSTRACT

Materialized views of a database are generated for query optimization by creating a query definition of a materialized view including a left outer or a right outer join to generate a joined database table and adding a non-nullable virtual tagging column to the right original database table with a value indicating whether a null entry came from an original database table or has been inserted to indicate that a row or column value does not exist as a result of the join operation. A materialized view is created using the query definition and query results of the joined database table with the virtual tagging column. To remove duplicate entries in at least one of the original database tables, at least one of the original database tables used to create the joined table is harmonized using a “group by” command

### CROSS-REFERENCE TO RELATED APPLICATIONS

This application is a continuation application of International Application No. PCT/CN2019/106062, filed Sep. 17, 2019, and entitled “Materialized Views for Database Query Optimization,” which claims the benefit of priority to U.S. Provisional Patent Application No. 62/734,667, filed on Sep. 21, 2018, and entitled “Materialized Views for Database Query Optimization,” both applications of which are hereby incorporated by reference in their entireties.

### TECHNICAL FIELD

The disclosure herein is directed to database query optimization, and, more particularly, to a system and method to implement materialized view creation and exploitation for query optimization in database applications.

### BACKGROUND

In traditional data warehouses (like Oracle, Teradata, and DB2 databases), the applications often submit complex structured query language (SQL) queries for data analytics. Such complex analytic queries typically involve a join of multiple tables, a group by clause to aggregate data on different dimensions, followed by sorting. The following is a typical example that computes the monthly sales revenue of products for each product category for the years 2017 and 2018 only:

Q:

```
select product_category, time_year, time_month, sum(sales_amount)
from Sales, Product, Time_dim
where Sales.product_id = Product.product_id
  and Sales.sales_date_id= Time_dim.date_id
  and time_year in (2017, 2018)
group by item_category, time_year, time_month
```

Using data warehouse terminology, the Sales table is generally referred to as the “fact” table as the Sales table contains the information about the sales transactions. In other to find the product category, one would have to join the Sales table with the Product table. The Product table is generally referred to as a “dimension” table, which is a companion table to a fact table, in this case, the Sales table. After the join, one would be able to find out more details about the sales transaction such as the product details, and the like. Likewise, there are other dimension tables that may be needed for analysis. In the above example, joining the Time dimension table is needed to find out the year, month, and even quarter information. In real-life applications, queries are often more complex than just joining with a couple of tables. In many cases, the fact table will be joining with 5-10 dimension tables and one or more filtering conditions.

A “join” operation in a data warehouse/database has been known to be very time and resource consuming. The “group by” operation requires a “sort” operation, which is also expensive. It is not unusual that evaluating such complex queries may take many minutes or even hours to complete. Database vendors have devised various techniques to speeding up the query processing time. For example, materialized view has been used by Oracle: https://docs.oracle.com/cd/A97630_01/server.920/a96567/repmview.htm and IBM: https://www.ibm.com/support/knowledgecenter/en/SSEPEK_10.0.0/perf/src/tpc/db2z_createmqt.html to speed up the query processing time of complex analytic queries.

Materialized views can improve query performance by orders of magnitude by avoiding re-computation of a query's expensive operations, such as joins, sorts, and the like. A materialized view is a database object that contains the results of a query. For example, it may be a local copy of data located remotely or may be a subset of the rows and/or columns of a table or join result. A materialized view may also be a summary using an aggregate function, and indexes can be built on any column. With a materialized view, the query result is cached as a concrete “materialized” table that may be updated from the original base tables from time to time, which enables much more efficient access but at the cost of extra storage and of some data being potentially out-of-date. Materialized views find use typically in data warehousing scenarios where frequent queries of the actual base tables can be expensive.

However, materialized views redundantly store data that is derivable from other data, so they consume extra storage space and must be updated to maintain their consistency with the source data whenever it changes, either periodically (deferred or full refresh) or as part of the same transaction (immediate refresh). Furthermore, a materialized view requires its own indexes for efficient access. The benefit of a materialized relative to its cost is therefore maximized if the materialized view benefits many queries, particularly costly queries, or frequently executed queries in the workload. Much research and development have been focused on query rewrite matching/optimization, incremental materialized view maintenance, and an advisor that recommends what materialized views to create involving an outer join.

Materialized view technology may be understood by using the above query as an example Consider creating a table materialized view (MV) that stores the query result of the following query:

```
Create table MV (product_category, time_year, time_month, sales_amount) as
  (select product_category, time_year, time_month, sum(sales_amount)
  from Sales, Product, Time_dim
  where Sales.product_id = Product.product_id
  and Sales.sales_date_id= Time_dim.date_id
group by item_category, time_year, time_month)
```

Essentially, the table MV pre-computes the join of the fact table with two dimension tables and performs pre-aggregates on the sales volume. Assuming that the fact and dimension tables have not been updated since the table MV has been populated with the query result, an important question becomes whether the query Q be answered by processing the data in MV instead of performing the complex join and group by operations.

Previously, it has been shown that one can prove that the query Q can indeed be answered by using the content of MV, but additional operations may be needed. In this example, the query Q can be rewritten as:

select product_category, time_year, time_month, sales_amount
from MV
where time_year in (2017, 2018)

With this rewrite optimization, the query Q can be returned much faster than performing complex joins. Furthermore, the MV is typically much smaller in size, and thus reading this MV table will take a much shorter time.

Taking this approach further, it is possible that one can ask the following query: find the total sale revenue for each product category in 2017 and 2018. In this example the query is written as:

select product_category, sum(sales_amount)
from MV
where time_year in (2017, 2018)
group by item_category

The rewritten query will still need a “group by” operation on a smaller set of grouping items but the rewritten query accesses the MV table only, and therefore, complex join operations are avoided.

With materialized view technology, complex queries can be processed much more efficiently, and thus it offers interactive response time capability to complex data analysis applications. Materialized view technology involves query matching and performing subsumption tests, essentially proving that the query can be evaluated against the materialized view logically, and without missing any data.

However, several assumptions made in databases and data warehouses may no longer be valid in recently developed data lake solutions where “schema-on-read” is the predominant way of analyzing data. A data lake is a system or repository of data in its natural format and may be a single store of all enterprise data including data used for tasks such as reporting, visualization, and analytics, and machine learning. A data lake can include structured date from relational databases, semi-structured data (e.g., XML, JSON, etc.), unstructured data (e.g., emails, documents, PDFs), and binary data (images, audio, video). A technique is needed that extends existing data lake solutions to provide better materialized view creation and exploitation for query optimization.

Related research and development has been conducted in the area of materialized view advisors. For example, https://www.ibm.com/support/knowledgecenter/zh/SSEPGG_9.5.0/com.ibm.db2.1uw.admin.perf.doc/doc/c0005144.html and https://pdfs.semanticscholar.org/bfde/fd687a5d129657e75c1bbb44925d54fc9e0f.pdf examine and analyze the query history and makes a recommendation of what materialized views to create. The idea is that the recommended materialized views will likely be used (via query rewrite/matching) to speed up historical queries in hope that future queries will look like the historical version.

In traditional data warehouses, the dimension tables are often required to have a primary key, and the fact tables will have foreign keys that can be used to join with the dimension tables. In a relational database model, a primary key is a specific choice of a minimal set of attributes (columns) that uniquely specify a tuple (row) in a relation (table). A primary key identifies which attributes identify a record and in simple cases are simply a single attribute, a unique ID. On the other hand, a foreign key is a field or collection of fields in one table that uniquely identifies a row of another table or the same table. The foreign key is defined in a second table, but it refers to the primary key or a unique key in the first table.

Also, in traditional data warehouses, one can easily enforce nullability. A null is a special marker used in SQL to indicate that a data value does not exist in the database. In other words, a null value indicates a lack of a value, which is not the same thing as a value of zero.

Oracle documentation: https://docs.oracle.com/en/database/oracle/oracle-database/18/dwhsg/advanced-query-rewrite-materialized-views.html#GUID-C4AA632B-09EE-4A67-95B4-D6DD7B18950A supports defining a left join of a left table and a right table in materialized views where the right table is considered to be a tuple-preserving operand and the left table is considered as a null-producing operand. However, the left join has certain restrictions. For example, Oracle requires the dimension table to have the primary key in order to appear in a left outer join in a materialized view. SQL outer joins, including left outer joins, right outer joins, and full outer joins, automatically produce nulls as placeholders for missing values in related tables. For left outer joins, for instance, nulls are produced in place of rows missing from the table appearing on the right-hand side of the left outer join operator. The primary key enforces uniqueness and is not-nullable. Alternatively, the database designers would enforce uniqueness and non-nullability during the extract, transform, load (ETL) process, or users would be required to declare “informational constraints” for query optimization. Other restrictions include requiring that the materialized views contain join conditions and no filter condition, that the primary key or rowid is on the right side of a left join (null-producing operand), and that columns are aggregated on the left side of left join (tuple-preserving operand). Furthermore, Oracle documentation refers to query matching optimization but does not cover materialized view recommendation. By way of example, the following exemplifies the Oracle approach:

Select SUM(s.amount_sold), p.prod_name
FROM sales s LEFT JOIN product p
ON s.prod_id = p.prod_id
GROUP BY p.prod_name

In SparkSQL and many other big data lake solutions, it is quite common that tables do not have a primary key or rowid, i.e. columns cannot be guaranteed on uniqueness and to be not-nullable. Users typically load the data into the data lake or data warehouse without specifying the schema or constraints.

Prior art techniques thus put significant restrictions on the type of materialized view that can be created with an outer join. For example, a primary key must be declared. No materialized view advisor would make this type of recommendation. Also, there has been no adoption of a materialized view in query-result set for faster query response time. As a result, traditional methods of recommending materialized views creation and exploiting materialized views for query optimization are not adequate.

In another aspect of data lake solutions, especially in the cloud environment, storage cost and size has dramatically been improved, unlike in traditional data warehouses where storage is generally quite expensive and space is limited. As a result of this technology change, it is quite common for data lake solutions in the cloud environment to offer storing the queries and their result sets in the cloud storage for a period of time. For example, both Snowflake Computing and AWS Athena offer this query history and stored result sets capability. These systems claim that if a new query matches exactly any stored query and the underlying tables have not been updated, the corresponding result set can be returned to users immediately, and thereby a lot of computation effort can be saved. However, these systems fail to recognize the potential use of materialized view technology in answering queries using the stored query result sets, particularly in the situation where the query does not match exactly any query in the history.

It is desired to address the shortcomings illustrated above as well as to provide other improvements to data lake query technologies.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

With cloud storage becoming cheaper, users can now afford to store the query history along with the query results in the cloud storage for a longer period of time. This creates an opportunity for creating and exploiting materialized view technology in this query-result set scenario that is not possible with existing technology. For example, by recognizing the need of handling null-values and duplicates, SQL query rewrite optimization may be extended to make recommendations of creating a materialized view including a left or right outer join without any limitation in the materialized view definition, to match and optimize outer join queries against materialized views including an outer join, and to adopt materialized view technology in speeding up the query processing in the presence of a large query-result set store.

The systems and methods described herein relaxes the restrictions of the prior art to recommend the creation of materialized views that comprise a left or right outer join with no restrictions on primary key and non-nullability in a data lake solution. Existing techniques in the prior art do not consider creating a materialized that handles the situation where there is no primary key or columns are nullable. The systems and methods described herein thus offer a more general solution.

By parsing and analyzing a number of queries including a left or right outer join and harmonized dimension table (i.e., duplicate-free), the systems and methods described herein will recommend one or more materialized views with an outer join that specially handles null values and duplicates, whereby future user queries can exploit the materialized view for speeding up query processing time.

In sample embodiments, when a user submits a query Q including a left or right outer join and/or harmonized dimension table wherein the null-producing table does not have a primary or unique key and may potentially contain null values, the query rewrite component will match and optimize against a general materialized view that contains a left or right outer join and can specially handle null values and harmonized table. The systems and methods described herein provides query rewrite optimization that recommends the creation of a materialized view with a left or right outer join that handles null values and duplicates, and without requiring a primary key. When a user has kept a history of queries and their corresponding result sets, further optimizing of future queries can be made possible by adopting and enhancing materialized view technology, both what materialized view to create and how on can handle a query match against potentially thousands of query-result sets. The query rewrite optimization matches queries against materialized views that are specially created to handle null values and duplicates and handles query-result set by adopting materialized view technology. As a result of the techniques described herein, a wide class of user queries can be evaluated with materialized views and the response time will be significantly reduced.

According to one aspect of the present disclosure, there is provided a computer-implemented method of generating materialized views of a database for query optimization, comprising creating, using one or more processors, a query definition of a materialized view including one of a left outer join of a left original database table and a right original database table and a right outer join of the right original database table and the left original database table to generate a joined database table. In sample embodiments, the right original database table is a null-producing operand of one of a left outer join and a right outer join. In sample embodiments, a non-nullable virtual tagging column is added by the one or more processors to the right original database table with a value indicating whether a null entry came from an original database table or has been inserted to indicate that a row or column value does not exist as a result of the left outer join or the right outer join operation. A materialized view is created by the one or more processors using the query definition and query results of the joined database table with the virtual tagging column.

According to another aspect of the present disclosure, there is provided a computer-implemented method of generating materialized views of a database for query optimization, comprising creating, using one or more processors, a query definition of a materialized view including one of an inner join, a left outer join of a left original database table and a right original database table, and a right outer join of the right original database table and the left original database table to generate a joined database table. In sample embodiments, an inner join typically requires each row in the two joined tables to have matching column values. An inner join creates a new result table by combining column values of two tables based upon the join-predicate. The query compares each row of the first table with each row of the second table to find all pairs of rows which satisfy the join-predicate. When the join-predicate is satisfied by matching non-NULL values, column values for each matched pair of rows of tables A and B are combined into a result row. In a sample embodiment, one of the left original database table and the right original database table in the inner join contains at least one duplicate entry that is harmonized by the one or more processors using a “group by” operation to remove the at least one duplicate entry. A materialized view is created by the one or more processors using the query definition and query results of the joined database table with the harmonized original database table.

According to another aspect of the present disclosure, there is provided a computer-implemented method of optimizing an inner join query using materialized views including one of a left outer join of a left original database table and a right original database table and a right outer join of the right original database table and the left original database table. The method includes retrieving, using one or more processors, a query definition in the materialized view including one of the left outer join of the left original database table and the right original database table and the right outer join of the right original database table and the left original database table with a non-nullable virtual tagging column added to the right original database table with a value indicating whether a null entry came from an original database table or has been inserted to indicate that a row or column value does not exist as a result of the left outer join or right outer join operation. In sample embodiments, the right original database table is a null-producing operand of one of a left outer join and a right outer join. The method includes the one or more processors determining whether a query result of an inner join is subsumed by the materialized view query definition and returning the inner join query result by retrieving a query result of the materialized view and by filtering all generated null rows from the query result of the materialized view.

According to another aspect of the present disclosure, there is provided a computer-implemented method of optimizing an inner join query using materialized views including a harmonized table of a database. The method includes retrieving, using one or more processors, a query definition in a materialized view including a join of a left original database table and a right original database table harmonized using a “group by” operation to remove at least one duplicate entry in at least one of the left original database table and the right original database table. The method includes the one or more processors determining whether a query result of an inner join is subsumed by the materialized view query definition and returning the inner join query result by retrieving a query result of the materialized view.

According to another aspect of the present disclosure, there is provided a processing device comprising a non-transitory memory comprising instructions and one or more processors in communication with the memory. The one or more processors execute the instructions to generate materialized views of a database for query optimization. The instructions stored in the non-transitory memory include instructions that are executed by the one or more processors to create a query definition of a materialized view including one of a left outer join of a left original database table and a right original database table and a right outer join of the right original database table and the left original database table to generate a joined database table, where the right original database table is a null-producing operand of one of a left outer join and a right outer join. In sample embodiments, the instructions include instructions that are executed by the one or more processors to add a non-nullable virtual tagging column to the right original database table with a value indicating whether a null entry came from an original database table or has been inserted to indicate that a row or column value does not exist as a result of the left outer join or the right outer join operation. The instructions further include instructions that are executed by the one or more processors to create a materialized view using the query definition and query results of the joined database table with the virtual tagging column. In other sample embodiments, the instructions in the memory are organized into functional processing modules that upon processing by the one or more processors provide means for performing each of these functions.

According to another aspect of the present disclosure, there is provided a processing device comprising a non-transitory memory comprising instructions and one or more processors in communication with the memory. The one or more processors execute the instructions to generate materialized views of a database for query optimization. The instructions stored in the non-transitory memory include instructions that are executed by the one or more processors to create a query definition of a materialized view including one of an inner join, a left outer join of a left original database table and a right original database table, and a right outer join of the right original database table and the left original database table to generate a joined database table. In sample embodiments, one of the left original database table and the right original database table in the inner join contains at least one duplicate entry that is harmonized by instructions including a “group by” operation that are executed by the one or more processors to remove the at least one duplicate entry. The instructions further include instructions that are executed by the one or more processors to create a materialized view using the query definition and query results of the joined database table with the harmonized original database table. In other sample embodiments, the instructions in the memory are organized into functional processing modules that upon processing by the one or more processors provide means for performing each of these functions.

According to another aspect of the present disclosure, there is provided a processing device comprising a non-transitory memory comprising instructions and one or more processors in communication with the memory. The one or more processors execute the instructions to optimize an inner join query using materialized views including one of a left outer join of a left original database table and a right original database table and a right outer join of the right original database table and the left original database table. The instructions stored in the non-transitory memory include instructions that are executed by the one or more processors to retrieve a query definition in the materialized view including one of the left outer join of the left original database table and the right original database table and the right outer join of the right original database table and the left original database table with a non-nullable virtual tagging column added to the right original database table with a value indicating whether a null entry came from an original database table or has been inserted to indicate that a row or column value does not exist as a result of the left outer join or right outer join operation. In sample embodiments, the right original database table is a null-producing operand of one of a left outer join and a right outer join. The instructions further include instructions that are executed by the one or more processors to determine whether a query result of an inner join is subsumed by the materialized view query definition and to return the inner join query result by retrieving a query result of the materialized view and by filtering all generated null rows from the query result of the materialized view. In other sample embodiments, the instructions in the memory are organized into functional processing modules that upon processing by the one or more processors provide means for performing each of these functions.

According to another aspect of the present disclosure, there is provided a processing device comprising a non-transitory memory comprising instructions and one or more processors in communication with the memory. The one or more processors execute the instructions to optimize an inner join query using materialized views including a harmonized table of a database. The instructions stored in the non-transitory memory include instructions that are executed by the one or more processors to retrieve a query definition in a materialized view including a join of a left original database table and a right original database table harmonized using a “group by” operation to remove at least one duplicate entry in at least one of the left original database table and the right original database table. The instructions further include instructions that are executed by the one or more processors to determine whether a query result of an inner join is subsumed by the materialized view query definition and to return the inner join query result by retrieving a query result of the materialized view. In other sample embodiments, the instructions in the memory are organized into functional processing modules that upon processing by the one or more processors provide means for performing each of these functions.

Optionally, in any of the preceding embodiments, adding a non-nullable virtual tagging column to the right original database table comprises inserting a constant integer value having a first value upon the left outer join or the right outer join operation finding a match and inserting a null entry upon the left outer join or the right outer join operation not finding a match.

Optionally, in any of the preceding embodiments, the virtual tagging column added to the right original database table is a part of the query results in the created materialized view.

Optionally, in any of the preceding embodiments, the created materialized view is stored with a materialized view query definition and the query results by executing the materialized view query definition.

Optionally, in any of the preceding embodiments, creating the materialized view comprises creating the materialized view using one of a left outer join and a right outer join of the left original database table and the right original database table with no restrictions on primary key, non-nullability of column values, and a join condition.

Optionally, in any of the preceding embodiments, creating the materialized view includes a join of original database tables with no restrictions on primary key, non-nullability of column values, and the join condition.

Optionally, in any of the preceding embodiments, the method further includes matching database tables in the inner join query against database tables in the materialized view query definition.

Optionally, in any of the preceding embodiments, the method further includes matching a join condition in the inner join query as a subset of a join condition in the materialized view query definition.

Optionally, in any of the preceding embodiments, filtering null rows from the query result of the materialized view comprises adding a predicate “COL IS NOT NULL”, where COL is a column of the added non-nullable virtual tagging column in the materialized view query definition.

Optionally, in any of the preceding embodiments, the method includes filtering rows from the materialized view query result by applying a filtering condition in the query but not in the materialized view query definition.

Optionally, in any of the preceding embodiments, the method further includes matching and optimizing outer join queries against materialized views including a left outer join of one of the left original database table and the right original database table with no restrictions on primary key, non-nullability and a join condition.

Optionally, in any of the preceding embodiments, the method further includes matching and optimizing outer join queries against materialized views including one of a harmonized left original database table and a harmonized right original database table with no restrictions on primary key, non-nullability and a join condition.

Any one of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a sample flow chart illustrating a computer-implemented method for recommending a materialized view in a sample embodiment.

FIG. 2 is a sample flow chart illustrating a computer-implemented method for query rewrite matching/optimization using a materialized view in a sample embodiment.

FIG. 3 illustrates the tables Sales and Product and their content and queries using a materialized view query in an example.

FIG. 4 illustrates the tables Sales and Product and their content and queries illustrating how a generated materialized view that includes a left join may be modified to include a non-nullable “tagging” column in a sample embodiment.

FIG. 5 illustrates an example of an improper aggregate result as a result of a duplicate entry in the Product table.

FIG. 6 illustrates a sample embodiment where a query is modified to include a join of the Sales table with the harmonized Product table (using a group by operation) to account for duplicates in the Product table.

FIG. 7 illustrates the rewriting of an inner join query with a left join materialized view without a group by operation in order to identify non-matching rows in a sample embodiment.

FIG. 8 illustrates a rewrite of the left join query with a left join materialized view in a sample embodiment.

FIG. 9 illustrates a rewrite of the left join query where the materialized view remains the same, but the user query is now an inner join instead of an outer join.

FIG. 10 is a sample flow chart illustrating a computer-implemented method of generating materialized views of a database for query optimization in a sample embodiment.

FIG. 11 is a sample flow chart illustrating another computer-implemented method of generating materialized views of a database for query optimization in a sample embodiment.

FIG. 12 is a sample flow chart illustrating a computer-implemented method of optimizing an inner join query using materialized views including either a left outer join of a left original database table and a right original database table or a right outer join of the right original database table and the left original database table.

FIG. 13 is a sample flow chart illustrating a computer-implemented method of optimizing an inner join query using materialized views including a harmonized table of a database.

FIG. 14 is a block diagram illustrating a data lake query engine for implementing materialized view creation and exploitation for query optimization in response to user queries in data lake applications in sample embodiments.

### DETAILED DESCRIPTION

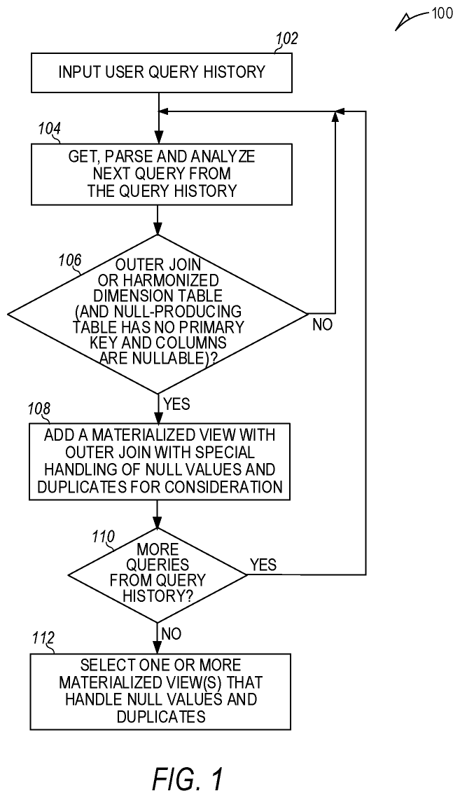

It should be understood at the out set that although an illustrative implementation of one or more embodiments are provided below, the disclosed systems and/or methods described with respect to FIGS. 1-14 may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In the following description, reference is made to the accompanying drawings that form a part hereof, and in which is shown by way of illustration specific embodiments which may be practiced. These embodiments are described in sufficient detail to enable those skilled in the art to practice the systems and methods described herein, and it is to be understood that other embodiments may be utilized, and that structural, logical and electrical changes may be made without departing from the scope of the present disclosure. The following description of example embodiments is, therefore, not to be taken in a limited sense, and the scope of the present disclosure is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

As noted above, existing prior art techniques generally do not consider creating a materialized view that handles the situation where there is no primary key or columns are nullable in a data lake environment. Prior art data lake solutions generally require the dimension table to have a primary key. In contrast, the systems and methods described herein do not require a primary key to be declared or the enforcement of the non-nullability of columns. The systems and methods described herein offer a more general solution, and therefore allows more queries to be processed using materialized views, resulting in significant query performance improvement.

Furthermore, existing systems do not apply materialized view technology to the query-result set scenarios. Instead, these existing systems return a given result set only when the query matches a historical version exactly. The systems and methods described herein further offer a general solution to query-result set scenarios by adopting materialized view technology. As a result, more queries can be evaluated using stored result sets directly and without going through the complex operations that require expensive query processing (such as joins and group by). The systems and methods described herein significantly speed up complex analytics query processing, especially involving a left or right outer join in a materialized view. The complexity of using the system is further reduced by automatically generating materialized views involving an outer join with virtually no restrictions. The resulting systems and methods significantly speed up the query rewrite matching optimization and creation in query-result set scenario where there are many queries and corresponding result sets.

FIG. 1 is a sample flow chart illustrating a computer-implemented method 100 for recommending a materialized view in a sample embodiment. When a user has kept a history of queries and their corresponding result sets, further optimizing of future queries can be made possible by adopting and enhancing materialized view technology: both what materialized view to create and how one can handle a query match against potentially thousands of query-result sets. As illustrated in FIG. 1, the method 100 of recommending a materialized view starts at 102 by retrieving the user query history over many queries. At 104, the next query from the query history is obtained, parsed, and analyzed. At 106, the method 100 determines whether the next query includes an outer join or a harmonized dimension table and whether a null-producing table has no primary key and the columns are nullable. If these conditions are not met, the method 100 returns to 104 to obtain, parse, and analyze the next query from the query history. However, if the conditions at 106 are met, the method 100 advances to 108 to add a materialized view with outer join with special handling of null values and duplicates for consideration using the techniques described herein. If it is determined at 110 that another query is available in the query history, the method 100 returns to 104 to repeat steps 104-108 for the next query. If no more queries are available for analysis, one or more materialized views are selected at 112 that handle null values and duplicates as described herein.

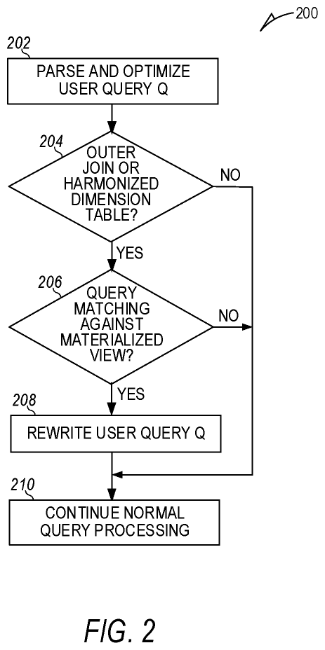

FIG. 2 is a sample flow chart illustrating a computer-implemented method for query rewrite matching/optimization using the recommended materialized view determined in the method 100 of FIG. 1 in a sample embodiment. As illustrated, the user query Q is parsed and optimized at 202. If an outer join or harmonized dimension table is included in the user query at 204, the method 200 determines at 206 if the query matches the recommended materialized view. If so, the user query Q is rewritten at 208 and normal query processing continues at 210. If the conditions at 204 and 206 are not met, the user query Q is not rewritten, and normal query processing continues.

In sample embodiments described below, by parsing and analyzing a number of queries involving an outer join and harmonized dimension table (i.e., duplicate-free), the method 100 of FIG. 1 recommends one or more materialized views with outer join that specially handles null values and duplicates, whereby future user queries can exploit the materialized view for speeding up query processing time by rewriting the query matching/optimization using a materialized view as illustrated in FIG. 2.

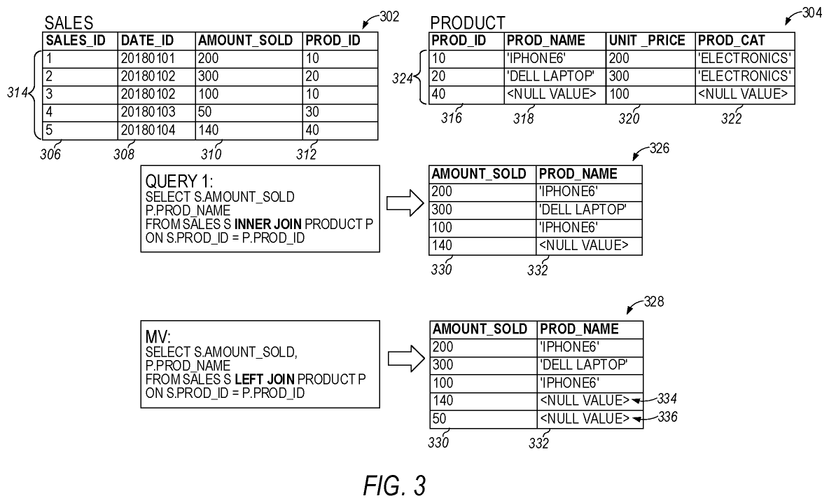

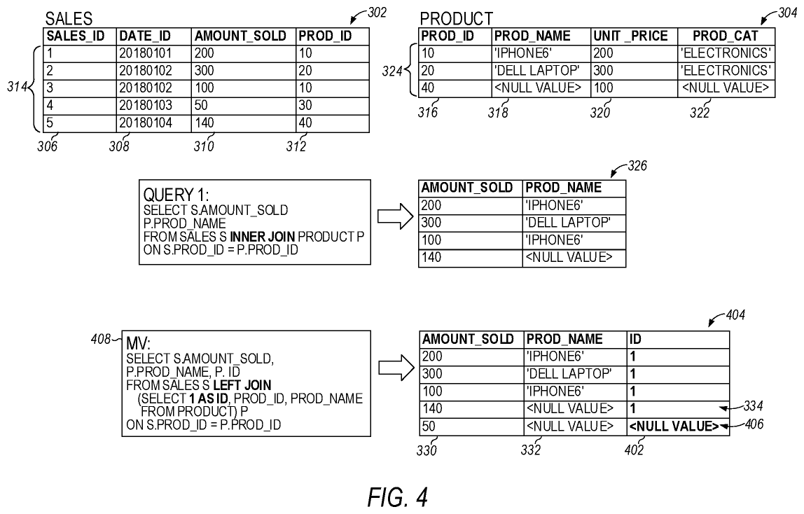

To illustrate the methods 100 and 200 of FIG. 1 and FIG. 2 in operation, some concrete examples will now be described with respect to FIG. 3 and FIG. 4. First, the challenges in handling an outer join are considered.

FIG. 3 illustrates the tables Sales 302 and Product 304 and their content in an example As illustrated, the Sales table 302 includes columns for Sales ID (306), Date ID (308), Amount Sold (310), and Product ID (312), while the rows 314 correspond to the data for different Sales IDs. Product table 304 includes columns for Product ID (316), Product Name (318), Unit Price (320), and Product Category (322), while the rows 324 correspond to the data for different Product IDs. A materialized view MV 328 is created as:

SELECT s.amount_sold, p.prod_name
FROM Sales s LEFT JOIN Product p
ON s.prod_id = p.prod_id

And the user query in Query 1 326 is:

SELECT s.amount_sold, p.prod_name
FROM Sales s INNER JOIN Product p
ON s.prod_id = p.prod_id

The content of the materialized view is shown at 308, including columns Amount Sold (330) and Product Name (332), derived as a left outer join of left original database table 302 and right original database table 304 (or conversely, a right outer join of the right original database table 304 and the left original database table 302). In this example, the right original database table 304 is a null-producing operand of either the left outer join or the right outer join. In either case, the resulting MV 328 does not differentiate the null value 334 from the base table 304 from the null value 336 generated due to a non-matching row between tables 302 and 304 during the inner join. The fact that null values are possible and admissible data values in the database means that there is no easy way to differentiate the null value 334 from the base table from the null value 336 that is generated due to a non-matching condition between the Sales and Product tables. As a result, the MV 328 content cannot be used to answer the user Query1 326. In order to make use of a query rewrite using a materialized view, a technique is needed to identify the null values that are generated due to non-matching rows so that such null values may be distinguished from the null values in a base table.

The method 100 of FIG. 1 addresses this problem by obtaining, parsing, and analyzing the queries in the user's query history at 104 to identify a situation where there is an outer join and the tables do not have a primary key and may contain null values at 106. If such conditions are satisfied, the recommended materialized view contains an outer join with a non-nullable “tagging” column that allows for “special handling” of a generated null value so that it may be differentiated due to the outer join non-matching condition. A join column of the null-producing operand may be added to the output of the materialized view, assuming that the join condition is an equality predicate, or a non-nullable column may be added to the null-producing operand. An equality predicate means that the columns are compared if they have the same value. For example, if a first table T (A integer) and a second table S (B integer) both have a single column of integer data type, an equality predicate would be “T.A=S.B,” meaning that the column A of a T row is being compared against the column B of another S row. However, it will be appreciated that adding a join column may not be desirable especially if there is a group by clause involved, and the join column should also appear in the group by clause.

In sample embodiments, the existing query rewrite matching/optimization may be extended and enhanced to handle matching the “tagging” column added to materialized view recommended at 108. For example, a generated materialized view 402 that includes a left join may be modified to include a non-nullable column 404 (denoted as “tagging” column) as illustrated in FIG. 4. In this example, a non-nullable virtual tagging column 404 is added to the right original database table. In FIG. 4, the column 404 includes an ID value of “1” when the value (including any null value) is taken from the base table 304. However, if the outer join condition is not met (i.e., non-matching row), the outer join will preserve the row from the Sales table 302 together with null values for the Product table 304. A value of “<null value>” will be added in column 404 at 406 when the null value is generated due to a non-matching condition between the Sales and Product tables 302 and 304, respectively. With this special “tagging” column 404, one can easily identify which rows are due to the non-matching condition.

A materialized view is created using the query definition and corresponding query results of the joined database table 402 with the virtual tagging column 404. For example, based upon tracking historical user queries and making use of a left join, the method 100 at step 108 would recommend the creation of a materialized view MV from the stored result set using query 408:

```
SELECT s.amount_sold, p.prod_name, p.ID
FROM Sales s LEFT JOIN
  (SELECT 1 as ID, prod_id, prod_name
  FROM Product) p
ON s.prod_id = p.prod_id
```

Using the method 200 of FIG. 2 with the created materialized view (MV) 404, the query Q1 may be rewritten using the created MV 404 as:

SELECT s.amount_sold, p.prod_name
FROM MV
WHERE ID is not null

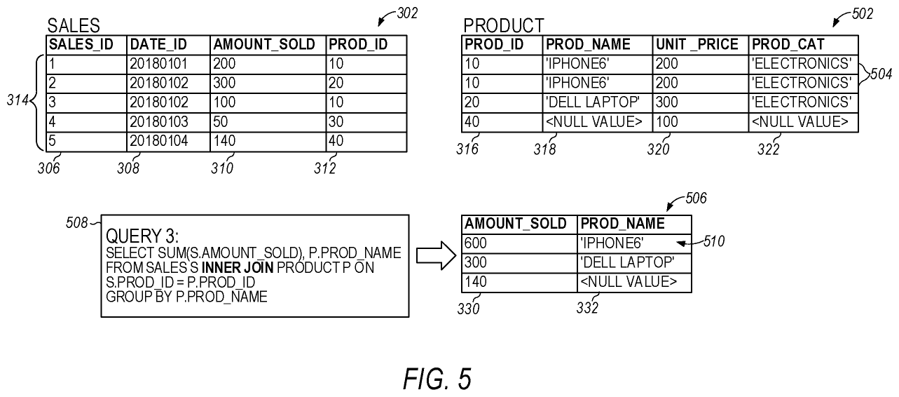

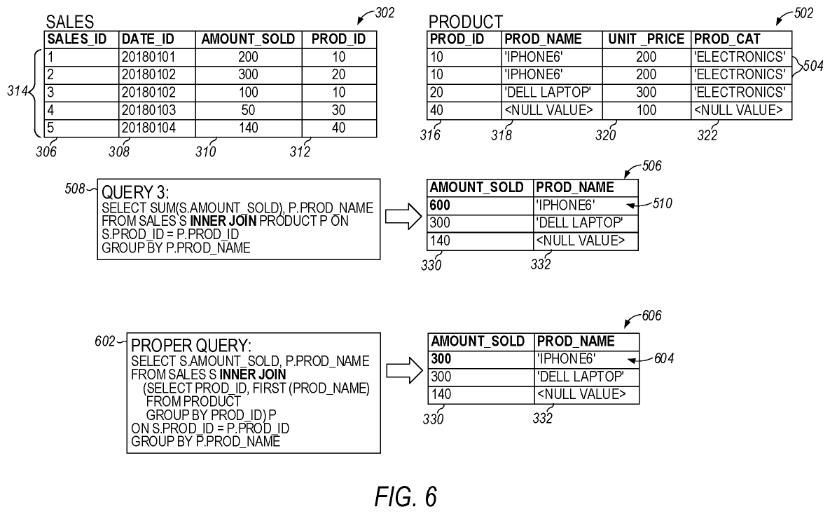

In accordance with another feature of the system and methods described herein, it is recognized that it is often the case that in data lake solution tables may contain duplicates as no one has declared any primary or unique key (if such declaration is allowed). The example illustrated in FIG. 5 and FIG. 6 illustrates the problem of aggregating rows in the presence of duplicate rows.

As illustrated in FIG. 5, when a dimension table (e.g., Product) 502 has duplicate rows as illustrated at 504, the aggregate result (e.g., sum) is not realistic. The aggregate result table 506 in response to Query3 (508) includes an amount (600) in row 510 rather than the proper result (300) because of the duplicate entries 504. To handle this situation, the join is modified to include a “harmonized” dimension table that is duplicate-free.

As illustrated in FIG. 6, harmonizing a Product table that is duplicate-free includes a “group by” operation in the Proper Query as illustrated at 602. The proper result (300) is then obtained in row 604 of aggregate result table 606 as a result of writing the join using harmonized tables.

The method for removing duplicates in the dimension tables (such as the Product table 502 in FIG. 5 and FIG. 6) includes enhancing the query rewrite matching algorithm to handle harmonized tables and recommending/advising the creation of materialized views involving harmonized tables. In the example of FIG. 6, the proper query 602 should include a join of the Sales table 302 with the harmonized Product table (using a group by operation grouped by product ID) to remove redundancy. The aggregate value (300) in row 604 would then make sense.

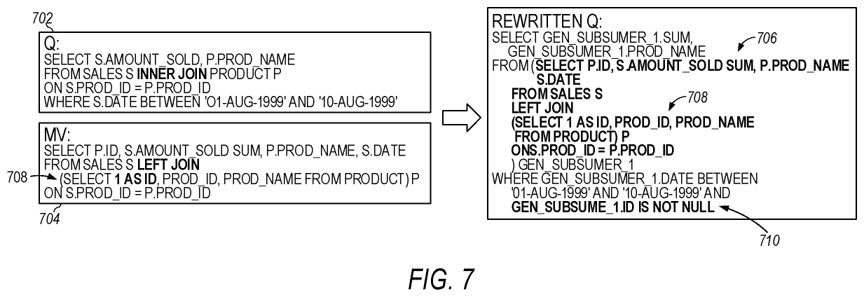

The following examples further illustrate with respect to FIGS. 7-9 how the above techniques for distinguishing null values and handling duplicate table entries may be combined in sample embodiments.

FIG. 7 illustrates the rewriting of an inner join query 702 with a left join materialized view 704 without a group by operation in order to identify non-matching rows. The rewritten query 706 includes the materialized view including a check at 708 and 710 if the outer join condition is not met (i.e., non-matching row). This check distinguishes between the null values that are generated due to non-matching rows so that such null values may be distinguished from the null values in a base table.

Since the dimension tables do not have primary keys, the harmonized dimension tables described above are used to enforce uniqueness. For example:

SELECT SUM(s.amount_sold),
gen_harmonized_1.prod_name
FROM sales s
LEFT JOIN
(SELECT p.prod_id, FIRST(p.prod_name) prod_name
FROM product p
GROUP BY p.prod_id) gen_harmonized_1
ON s.prod_id = gen_harmonized_1.prod_id
GROUP BY gen_harmonized_1.prod_name

Without harmonizing the dimension tables, the aggregate functions may return invalid results when there are duplicates in the dimension tables that match the join condition. On the other hand, as noted above, when a harmonized dimension table is used, SUM(s.amount_sold) makes sense when prod_id is not null. It is thus desirable to use a harmonized dimension table with tagging to identify the generated null values due to the left join as follows:

SELECT gen_harmonized_1.id, SUM(s.amount_sold),
gen_harmonized_1.prod_name
FROM sales s
LEFT JOIN
(SELECT 1 id, p.prod_id, FIRST(p.prod_name) prod_name
FROM product p
GROUP BY p.prod_id) gen_harmonized_1
ON s.prod_id = gen_harmonized_1.prod_id
GROUP BY gen_harmonized_1.id, gen_harmonized_1.prod_name
HAVING gen_harmonized_1.id is not null

When a sales row does not match any product, the “id” column value is null after the left join, and thus the entire null group in “id” can be removed. In this example, the SUM(s.amount_sold) makes sense even if prod_id is null or there is no corresponding matching row in the Product table.

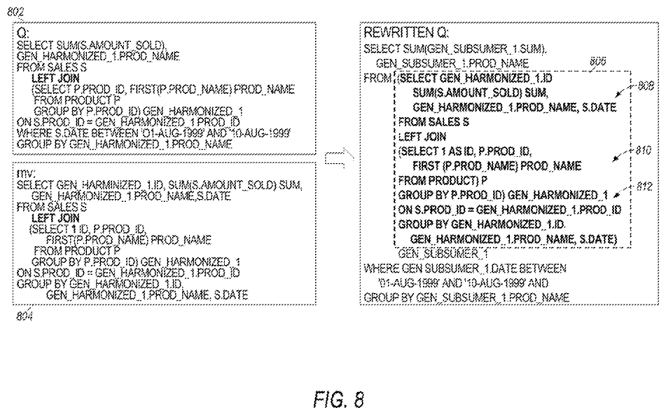

FIG. 8 illustrates a rewrite of the left join query 802 with a left join materialized view 804. In FIG. 8, both the query 802 and the materialized view 804 contain the left join. The rewritten query 806 is simply accessing the MV table at 808, followed by filtering at 810 and the group by operation at 812.

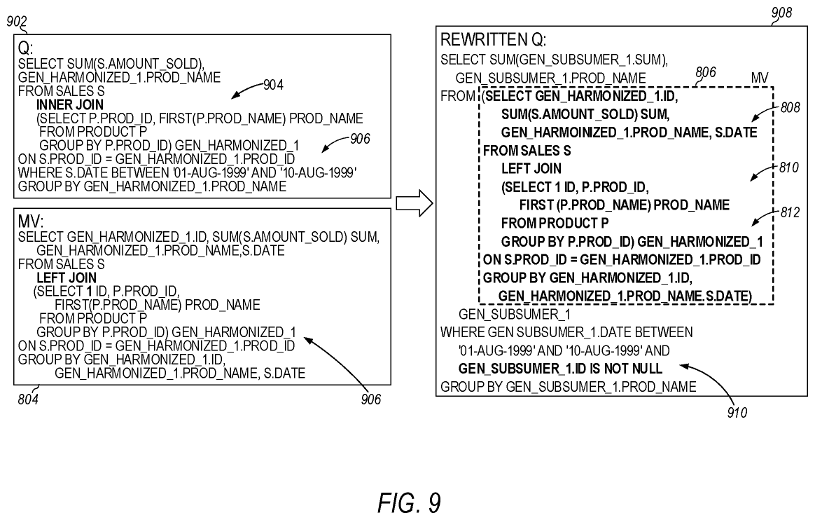

In FIG. 9, the materialized view 804 remains the same but the user query 902 is now an inner join (instead of outer join) as shown at 904. Also, the harmonized dimension table includes the tagging column at 906. The rewritten query 908 includes an extra filtering of the Sales and Product tables for “IS NOT NULL” to remove generated rows with null values from the previously stored result, as indicated at 910. As noted above with respect to FIG. 1, the query logs are parsed and analyzed to recommend the most appropriate materialized view, and the result is optimized from the materialized view.

In the illustrated examples, it is noted that a select box represents the portion of the query that performs joins, filtering, and projection, while a group by box represents the portion of the query that performs a grouping and aggregate function. In the above examples, the systems and methods handle only query matching for select and group by boxes. Using this notation, the detailed algorithm for performing query matching optimization in a sample embodiment can be described based on patterns for the Subsumer (materialized view (MV)) and Subsumee (Query (Q)) as:

Subsumer (MV)
Modular plan of subsumer is of the form group by-select.
Predicates of the select box have only left join without filter.
Canonicalized modular plan is in the form of left child corresponding to left side of left join or right child corresponding to right side of left join.
Right child of select box is a harmonized table whose group by predicate has only one column and the select output has a tag field with the value 1.
Output list of the table contains a corresponding group by column and some functions of first( ), first_value( ), last( ), and last_value( ).
Columns of aggregates in the group by box are from the left child of the select box.

Subsumee ( )
Same as subsumer except that predicates of the select box can have left/inner join and filters and there is no need to have a tag field.

Select Boxes
Matching Conditions
   1. One-to-one child matches.
   2. Every subsumee predicate matches with/derivable from a subsumer predicate or is derivable from output of subsumer.
   3. Each subsumee output is derivable from the subsumer's output.

Compensation
Apply all of the subsumee's predicates that do not have matching subsumer predicates.
Apply ‘column is NOT NULL’ to tag column of the right child if subsumee does not involve an outer join.
Derive all the subsumee's output from the subsumer's output.

Group by Boxes
Matching conditions and compensation are the same as those without an outer join.

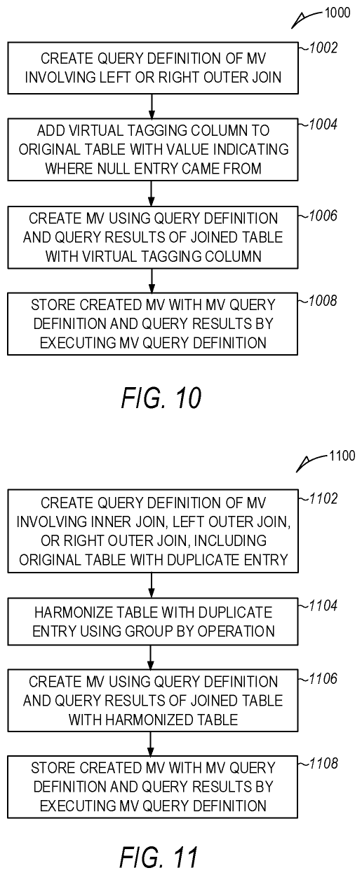

FIG. 10 is a flow diagram of a method 1000 of generating materialized views of a database for query optimization in a sample embodiment. As illustrated, the method 1000 starts at 1002 by creating a query definition of a materialized view including either a left outer join of a left original database table and a right original database table or a right outer join of the right original database table and the left original database table to generate a joined database table. The right original database table is a null-producing operand of either the left outer join or the right outer join. In order to differentiate the null value from a base table from a null value generated due to a non-matching row between the tables during the inner join, a non-nullable virtual tagging column is added at 1004 to the right original database table with a value indicating whether a null entry came from an original database table or has been inserted to indicate that a row or column value does not exist as a result of the left outer join or the right outer join operation. Adding a non-nullable virtual tagging column to the right original database table includes inserting a constant integer value having a first value upon the left outer join or the right outer join operation finding a match and inserting a null entry upon the left outer join or the right join operation not finding a match. In sample embodiments, the virtual tagging column added to the right original database table is a part of the query results in the created materialized view.

A materialized view is created at 1006 using the query definition and corresponding query results of the joined database table with the virtual tagging column added in 1004. Creating the materialized view may include creating the materialized view using wither a left outer join or a right outer join of the left original database table and the right original database table with no restrictions on primary key, non-nullability of column values, and a join condition using the techniques described herein. The created materialized view is stored at 1008 with a materialized view query definition and the query results by executing the materialized view query definition.

FIG. 11 is a flow diagram of another method 1100 of generating materialized views of a database for query optimization in a sample embodiment. As illustrated, the method 1100 starts at 1102 by creating a query definition of a materialized view including either an inner join, a left outer join of a left original database table and a right original database table, or a right outer join of the right original database table and the left original database table to generate a joined database table. Either the left original database table or the right original database table contains at least one duplicate entry. Using the techniques described above, the original database table with duplicate entries is harmonized at 1104 using a “group by” operation to remove the duplicate entries. A materialized view is created at 1106 using the query definition and the corresponding query results of the joined database table with the harmonized original database table. As explained above, creating the materialized view includes a join of original database tables with no restrictions on primary key, non-nullability of column values, and the join condition. The created materialized view is stored at 1108 with the materialized view query definition and the corresponding query results by executing the materialized view query definition.

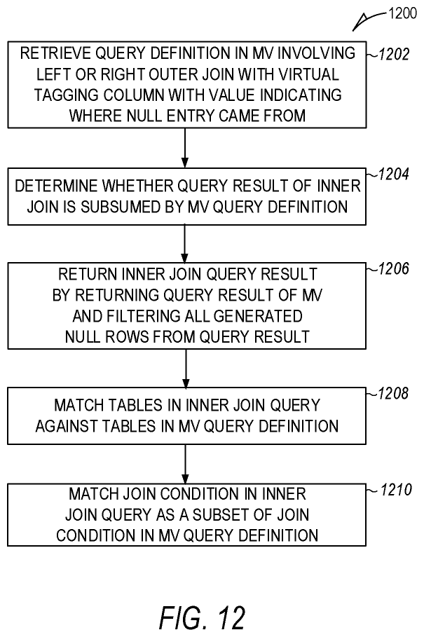

FIG. 12 is a flow diagram of a method 1200 of optimizing an inner join query using materialized views including either a left outer join of a left original database table and a right original database table or a right outer join of the right original database table and the left original database table. As illustrated, the method 1200 starts at 1202 by retrieving a query definition in the materialized view including either the left outer join of the left original database table and the right original database table or the right outer join of the right original database table and the left original database table with a non-nullable virtual tagging column added to the right original database table with a value indicating whether a null entry came from an original database table or has been inserted to indicate that a row or column value does not exist as a result of the left outer join or right outer join operation. In sample embodiments, the right original database table is a null-producing operand of either the left outer join or the right outer join. At 1204, the method 1200 determines whether a query result of an inner join is subsumed by the materialized view query definition. At 1206, the inner join query result is returned by retrieving a query result of the materialized view and by filtering all generated null rows from the query result of the materialized view. In a sample embodiment, filtering the null rows from the query result of the materialized view includes adding a predicate “COL IS NOT NULL”, where COL is a column of the added non-nullable virtual tagging column in the materialized view query definition. At 1208, database tables in the inner join query are matched against database tables in the materialized view query definition. At 1210, a join condition in the inner join query is matched as a subset of a join condition in the materialized view query definition.

As explained above, in the method 1200 of FIG. 12, the outer join queries may be matched and optimized against materialized views including a left outer join of either the left original database table or the right original database table with no restrictions on primary key, non-nullability and a join condition.

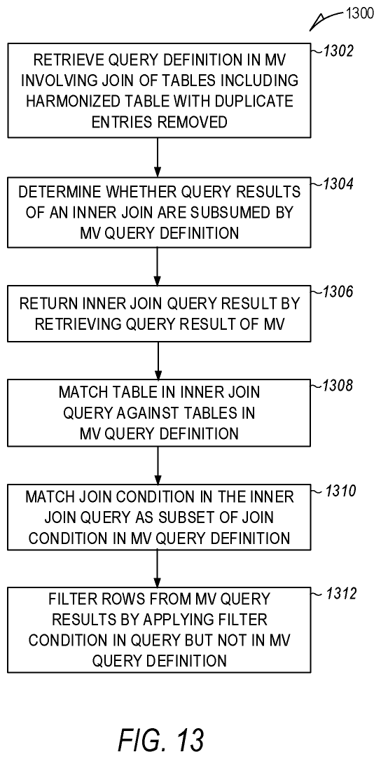

FIG. 13 is a flow diagram of a method 1300 of optimizing an inner join query using materialized views including a harmonized table of a database. As illustrated, the method 1300 starts at 1302 by retrieving a query definition in a materialized view including a join of a left original database table and a right original database table harmonized using a “group by” operation to remove at least one duplicate entry in the left original database table and/or the right original database table. At 1304, the method 1300 determines whether a query result of an inner join is subsumed by the materialized view query definition, and at 1306 the inner join query result is returned by retrieving a query result of the materialized view. At 1308, tables in the inner join query are matched against database tables in the materialized view query definition, and at 1310, a join condition in the inner join query is matched as a subset of a join condition in the materialized view query definition. At 1312, rows from the materialized view query result are filtered by applying a filtering condition in the query but not in the materialized view query definition.

As explained above, in the method 1300 of FIG. 13, matching and optimizing the outer join queries against materialized views includes either a harmonized left original database table or a harmonized right original database table with no restrictions on primary key, non-nullability and a join condition.

The systems and methods described herein creates a materialized view that handles the situation where there is no primary key or columns are nullable in a data lake environment. While the prior art would generally require the dimension table to have a primary key, the systems and methods described herein do not require a primary key to be declared or the enforcement of the non-nullability of columns. The systems and methods described herein offer a more general solution and allow more queries to be processed using materialized views, resulting in significant query performance improvement.

Furthermore, existing systems do not apply materialized view technology to the query-result set scenarios. Instead, the existing systems return prior result sets only when the query matches exactly the history query. The systems and methods described herein offer a general solution to query-result set scenarios and, as a result, more queries may benefit from the previously kept result sets. As a result, expensive query processing (such as joins and group by) can be avoided.

The general solution includes recommending the creation of materialized views that comprise an outer join with no restrictions on the primary key and non-nullability in a data lake solution, exploiting the recommended materialized views for better query rewrite optimization, and handling a very large query-result set query optimization via materialized view technology.

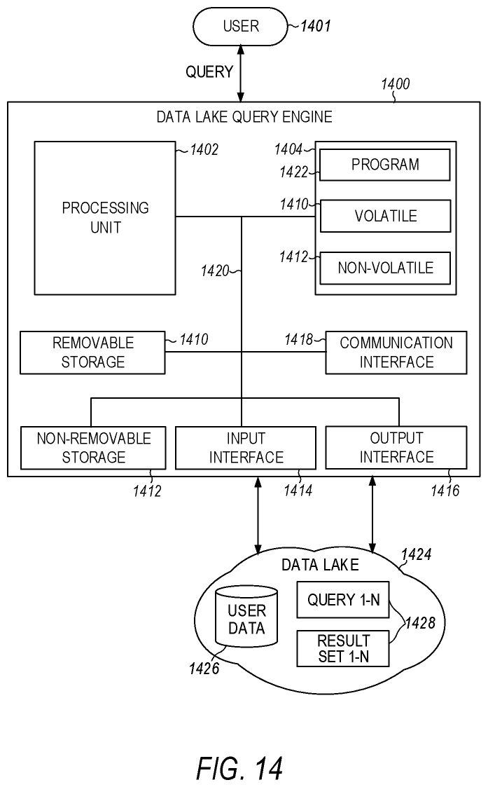

FIG. 14 is a block diagram illustrating circuitry in the form of a data lake query engine for implementing materialized view creation and exploitation for query optimization in response to user queries 1401 in data lake applications as described above with respect to FIGS. 1-13 according to sample embodiments. All components need not be used in various embodiments. One example computing device in the form of a computer 1400 may include a processing unit 1402, memory 1404, removable storage 1406, and non-removable storage 1408. Although the example computing device is illustrated and described as computer 1400, the computing device may be in different forms in different embodiments. For example, the computing device may instead be a smartphone, a tablet, smartwatch, or other computing device including the same or similar elements as illustrated and described with regard to FIG. 14. Devices, such as smartphones, tablets, and smartwatches, are generally collectively referred to as mobile devices or user equipment. Further, although the various data storage elements are illustrated as part of the computer 1400, the storage may also or alternatively include cloud-based storage accessible via a network, such as the Internet or server-based storage.

Memory 1404 may include volatile memory 1410 and non-volatile memory 1412. Computer 1400 also may include—or have access to a computing environment that includes—a variety of computer-readable media, such as volatile memory 1410 and non-volatile memory 1412, removable storage 1406 and non-removable storage 1408. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1400 may include or have access to a computing environment that includes input interface 1414, output interface 1416, and a communication interface 1418. Output interface 1416 may include a display device, such as a touchscreen, that also may serve as an input device. The input interface 1414 may include one or more of a touchscreen, touchpad, mouse, keyboard, camera, one or more device-specific buttons, one or more sensors integrated within or coupled via wired or wireless data connections to the computer 1400, and other input devices. The computer 1400 may operate in a networked environment using a communication connection to connect to one or more remote computers, such as database servers in a data lake 1424 including user data 1426 and stored queries and query-result sets 1428. The remote computer may include a personal computer (PC), server, router, network PC, a peer device or other common DFD network switch, or the like. The communication connection may include a Local Area Network (LAN), a Wide Area Network (WAN), cellular, Wi-Fi, Bluetooth, or other networks. According to one embodiment, the various components of computer 1400 are connected with a system bus 1420.

Computer-readable instructions stored on a computer-readable medium are executable by the processing unit 1402 of the computer 1400, such as a program 1422. The program 1422 in some embodiments comprises software that, upon execution by the processing unit 1402, performs the query optimization operations according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed to be transitory. Storage can also include networked storage, such as a storage area network (SAN). Computer program 1422 also may include instruction modules that upon processing cause processing unit 1402 to perform one or more methods or algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

It should be further understood that software including one or more computer-executable instructions that facilitate processing and operations as described above with reference to any one or all of steps of the disclosure can be installed in and sold with one or more computing devices consistent with the disclosure. Alternatively, the software can be obtained and loaded into one or more computing devices, including obtaining the software through physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code or instructions to perform functions (e.g., by operating on input data and/or generating an output). Method steps can also be performed by, and apparatus for performing the methods can be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory or both. The required elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors 1402, such that the instructions, upon execution by one or more processors 1402 cause the one or more processors 1402 to perform any one or more of the methodologies described herein. Accordingly, a “machine-readable medium” refers to a single storage apparatus or device, as well as “cloud-based” storage systems or “data lake” storage networks that include multiple storage apparatus or devices. The term “machine-readable medium” as used herein excludes signals per se to the extent such signals are deemed to be transitory.

Those skilled in the art will appreciate that while sample embodiments have been described in connection with methods for implementing materialized view creation and exploitation for query optimization in data lake applications, the disclosure described herein is not so limited. For example, the techniques described herein may be used to create and optimize materialized view queries in other database environments.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Although the present disclosure has been described with reference to specific features and embodiments thereof, it is evident that various modifications and combinations can be made thereto without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A computer-implemented method of generating materialized views of a database for query optimization, comprising:
creating, with one or more processors, a query definition of a materialized view including one of an inner join, a left outer join of a left original database table and a right original database table, and a right outer join of the right original database table and the left original database table to generate a joined database table, wherein the right original database table is a null-producing operand of one of a left outer join and a right outer join;
adding, with the one or more processors, a non-nullable virtual tagging column to the right original database table with a value indicating whether a null entry came from an original database table or has been inserted to indicate that a row or column value does not exist as a result of the left outer join or the right outer join operation; and
creating, with the one or more processors, a materialized view using the query definition and query results of the joined database table with the virtual tagging column

2. The method of claim 1, wherein adding a non-nullable virtual tagging column to the right original database table comprises inserting a constant integer value having a first value upon the left outer join or the right outer join operation finding a match and inserting a null entry upon the left outer join or the right outer join operation not finding a match.

3. The method of claim 1, wherein the virtual tagging column added to the right original database table is a part of the query results in the created materialized view.

4. The method of claim 1, further comprising the one or more processors storing the created materialized view with a materialized view query definition and the query results by executing the materialized view query definition.

5. The method of claim 1, wherein creating the materialized view comprises creating the materialized view using one of a left outer join and a right outer join of the left original database table and the right original database table with no restrictions on primary key, non-nullability of column values, and a join condition.

6. The method of claim 1, wherein one of the left original database table and the right original database table contains at least one duplicate entry, further comprising:
harmonizing, with the one or more processors, the one of the left original database table and the right original database table using a “group by” operation to remove the at least one duplicate entry; and
creating, with the one or more processors, a second materialized view using the query definition and query results of the joined database table with the harmonized original database table.

7. The method of claim 1, further comprising optimizing an inner join query using materialized views including one of the left outer join of the left original database table and the right original database table and the right outer join of the right original database table and the left original database table, by:
retrieving, with the one or more processors, a query definition in the materialized view including one of the left outer join of the left original database table and the right original database table and the right outer join of the right original database table and the left original database table with the non-nullable virtual tagging column added to the right original database table with the value indicating whether the null entry came from an original database table or has been inserted to indicate that the row or column value does not exist as a result of the left outer join or right outer join operation, wherein the right original database table is a null-producing operand of one of the left outer join and the right outer join;
determining, with the one or more processors, whether a query result of the inner join is subsumed by the materialized view query definition; and
returning, with the one or more processors, the inner join query result by retrieving a query result of the materialized view and by filtering all generated null rows from the query result of the materialized view.

8. The method of claim 7, further comprising the one or more processors matching database tables in the inner join query against database tables in the materialized view query definition.

9. The method of claim 7, further comprising the one or more processors matching a join condition in the inner join query as a subset of a join condition in the materialized view query definition.

10. The method of claim 7, wherein filtering null rows from the query result of the materialized view comprises adding a predicate “COL IS NOT NULL”, where COL is a column of the added non-nullable virtual tagging column in the materialized view query definition.

11. The method of claim 7, further comprising the one or more processors matching and optimizing outer join queries against materialized views including a left outer join of one of the left original database table and the right original database table with no restrictions on primary key, non-nullability and a join condition.

12. The method of claim 1, further comprising optimizing an inner join query using materialized views including a harmonized table of a database, by:
retrieving, with one or more processors, a query definition in a materialized view including a join of the left original database table and the right original database table harmonized using a “group by” operation to remove at least one duplicate entry in at least one of the left original database table and the right original database table;
determining, with the one or more processors, whether a query result of an inner join is subsumed by the materialized view query definition; and
returning, with the one or more processors, the inner join query result by retrieving a query result of the materialized view.

13. The method of claim 12, further comprising the one or more processors filtering rows from the materialized view query result by applying a filtering condition in the query but not in the materialized view query definition.

14. The method of claim 12, further comprising the one or more processors matching and optimizing outer join queries against materialized views including one of a harmonized left original database table and a harmonized right original database table with no restrictions on primary key, non-nullability and a join condition.

15. A system that generates materialized views of a database for query optimization, comprising:
a computer-readable medium that stores instructions; and
at least one processor that executes the instructions to perform operations comprising:
creating a query definition of a materialized view including one of an inner join, a left outer join of a left original database table and a right original database table, and a right outer join of the right original database table and the left original database table to generate a joined database table, wherein the right original database table is a null-producing operand of one of a left outer join and a right outer join;
adding a non-nullable virtual tagging column to the right original database table with a value indicating whether a null entry came from an original database table or has been inserted to indicate that a row or column value does not exist as a result of the left outer join or the right outer join operation; and
creating a materialized view using the query definition and query results of the joined database table with the virtual tagging column.

16. The system of claim 15, wherein one of the left original database table and the right original database table contains at least one duplicate entry, the at least one processor executing further instructions to perform operations comprising:
harmonizing the one of the left original database table and the right original database table using a “group by” operation to remove the at least one duplicate entry; and
creating a second materialized view using the query definition and query results of the joined database table with the harmonized original database table.

17. The system of claim 15, wherein the at least one processor executes further instructions to optimize an inner join query using materialized views including one of the left outer join of the left original database table and the right original database table and the right outer join of the right original database table and the left original database table, by performing operations comprising:
retrieving a query definition in the materialized view including one of the left outer join of the left original database table and the right original database table and the right outer join of the right original database table and the left original database table with the non-nullable virtual tagging column added to the right original database table with the value indicating whether the null entry came from an original database table or has been inserted to indicate that the row or column value does not exist as a result of the left outer join or right outer join operation, wherein the right original database table is a null-producing operand of one of the left outer join and the right outer join;
determining whether a query result of the inner join is subsumed by the materialized view query definition; and
returning the inner join query result by retrieving a query result of the materialized view and by filtering all generated null rows from the query result of the materialized view.

18. The system of claim 15, wherein the at least one processor executes further instructions to optimize an inner join query using materialized views including a harmonized table of a database, by performing operations comprising:
retrieving a query definition in a materialized view including a join of the left original database table and the right original database table harmonized using a “group by” operation to remove at least one duplicate entry in at least one of the left original database table and the right original database table;
determining whether a query result of an inner join is subsumed by the materialized view query definition; and
returning the inner join query result by retrieving a query result of the materialized view.

19. A non-transitory computer readable storage medium comprising instructions that upon execution by at least one processor cause the at least one processor to generate materialized views of a database for query optimization by performing operations comprising:
creating a query definition of a materialized view including one of an inner join, a left outer join of a left original database table and a right original database table, and a right outer join of the right original database table and the left original database table to generate a joined database table, wherein the right original database table is a null-producing operand of one of a left outer join and a right outer join;
adding a non-nullable virtual tagging column to the right original database table with a value indicating whether a null entry came from an original database table or has been inserted to indicate that a row or column value does not exist as a result of the left outer join or the right outer join operation; and
creating a materialized view using the query definition and query results of the joined database table with the virtual tagging column

20. The medium of claim 19, further comprising instructions that upon executed by the at least one processor cause the at least one processor to add a non-nullable virtual tagging column to the right original database table by inserting a constant integer value having a first value upon the left outer join or the right outer join operation finding a match and inserting a null entry upon the left outer join or the right outer join operation not finding a match, the virtual tagging column added to the right original database table being a part of the query results in the created materialized view.
